(19) United States
(12) Patent Application Publication
(10) Pub. No.: US 2003/0086594 A1
(43) Pub. Date: May 8, 2003

(54) Providing identity and security information

(76) Inventor: Raymond L. Gross, Washington Township, MI (US)

Correspondence Address: Christopher John Rudy, Ste. 8, 209 Huron Ave., Port Huron, MI, 48060, US

(21) Appl. No.: 10/216,934

(22) Filed: Aug. 12, 2002

Related U.S. Application Data
(60) Provisional application No. 60/338,764, filed on Dec. 4, 2001.

(51) Int. Cl. G06K 9/00

(52) U.S. Cl. 382/118

(57) ABSTRACT

Identity and security information is provided. Embodied as a method, it can include steps of providing a computer database structured to allow multi-user access and dynamic reporting of personnel data contained within the database; providing a portal that permits access to the database; receiving through the portal individual data to be matched against data contained in the database; and transmitting an individual report, which includes an image and identification character set of an individual. As a system, it can comprise the database in conjunction with hardware with which the database is operatively present.

### CROSS-REFERENCE CLAIM OF PRIORITY

This claims benefit under 35 USC 119(e) of U.S. provisional patent application No. 60/338,764 filed on Nov. 4, 2001 A.D. The complete specification of that application is incorporated herein by reference.

### FIELD AND PURVIEW OF THE INVENTION

The present invention concerns the provision of identity and security information of personnel. Generally, the information is associated with a computer database and accessed through a user portal, for example, over the Internet communications network.

### BACKGROUND TO THE INVENTION

The need to quickly and accurately identify individuals is of great importance, particularly in occupations where security and proper access is of concern. For example, in the on-site repair of semi-truck trailers and equipment, or in delivery businesses and so forth, it is important to know that a certain individual who claims to have a certain identity is in fact that individual, and to be able to determine that identity quickly. The same plainly would apply to rapid identity of persons claiming to be airport personnel to ensure that no unauthorized individuals are bypassing a security checkpoint, and so forth. Moreover, the reduction or elimination of fraud is a business and social necessity. For example, a hotel would be well served if its staff were able to quickly confirm that an individual is actually employed with a particular company and entitled to a corporate discount. It is frequently the case, however, that many of those who would need to know the identity of the individual under consideration are in locations distant from the headquarters or security staff of the servicing or originating organization or department, or are simply not part of the same organization.

In attempts to address some basic concerns, various art was developed. For instance, the following U.S. patent art is known:

U.S. Pat. No. 3,636,315 to Comeau. That discloses a guest identification apparatus and method, and relates to an apparatus and method for checking the identity of a person prior to recording charges incurred by that person as being incurred by a known person. The system is particularly useful in hotels and motels where a guest or other known person is permitted to incur expenses at various locations such as a restaurant where that person may not be known to the cashier. The person who wishes to make a charge provides the cashier or other employee with his name and other identifying information such as a room number or account number and, prior to recording this charge against the account of the person so identified, the cashier or other employee is provided with a visual display of correct descriptive information for comparison. If the information given by the charging guest is correct, the charges incurred are then recorded against the account of the known person. Thus, a local network is provided over which a hotel can verify in a simple manner the purported identity of a guest, say, by name and room number. The guest generally provides his own data.

U.S. Pat. No. 5,930,804 to Yu et al. That discloses and relates to a Web-based biometric authentication system and method. The system includes at least one Web client station (WCS), at least one Web server station (WSS), and an authentication center (AC). The WCS is linked to a Web cloud, and provides selected biometric data of an individual using the WCS. The WSS is also linked to the Web cloud. The AC is linked to at least one of the WCS and WSS so as to receive biometric data. The authentication center, having records of one or more enrolled individuals, provides for comparison of the provided data with selected records. In this patent is described the input of biometric data, for example, fingerprint, voiceprint, retinal pattern and/or typing pattern, which may be augmented with non-biometric data such as a password of a candidate from a remote site (WCS); the processing of that data at a central database (WSS); and the verification or rejection, or identification or failure to identify that data as corresponding or not corresponding to the candidate, and may provide further data from the WSS, for example, data for use in the case of a medical emergency. Generally, however, that invention is directed at denying on-line computer access to Web server crackers.

U.S. Pat. No. 6,091,946 to Ahvenainen. That discloses checking the access right of subscriber equipment, and relates to a radio system in which subscribers and terminals are not permanently connected, for example, a cellular communication system, as well as to a method for checking the access right of subscriber equipment in a mobile communication system. Thus, that invention is related to radio systems such as, for example, cell phones.

U.S. Pat. No. 6,137,895 to Al-Sheikh. That discloses and relates to a method for verifying the identity of a passenger. There, a conveyance boarding pass includes a human-cognizable image of the passenger as well as details of his travel itinerary. The image is collected using a device capable of generating an electronic image at a time when the identification of the passenger is presumptively verified. Upon presenting the boarding pass, a visual comparison is made of the image on the pass to that of the candidate passenger appearing at the gate or other location. The picture and itinerary may be stored in a computer database for further security or other uses. Generally, the personal data of the passenger is provided by the passenger himself.

It would be desirable to satisfy such long felt needs, in whole or at least in part, and improve upon the state of the art.

### FURTHER DISCLOSURE AND ILLUSTRATION OF THE INVENTION

In general, the present invention provides technology for providing identity and security information. Embodied as a method, it can comprise steps of

providing a computer database structured to allow multi-user access and dynamic reporting of personnel data contained within said database;

providing a portal that permits access to said database;

receiving through said portal individual data to be matched against data contained in said database; and

transmitting an individual report, which includes an image of an individual and an identification character set, for example, a identification number, of said individual.

As a system, it can comprise the database in conjunction with hardware with which the database is operatively present.

The invention is useful in identity and security operations.

Significantly, by the invention, one or more needs in the art are satisfied, in whole or in part, and the state of the art of identity and security is notably improved. The method of the present invention offers the user the ability to quickly search and retrieve personnel data for a particular individual to ensure that that individual, say, is actually employed with a particular organization. For example, in the on-site repair of semi-truck trailers and equipment of Customer Company by Servicing Group, or the delivery by Delivery Company to Receiving Business, it can be quickly determined that a certain individual who claims to have a certain identity is in fact that individual over the Internet, and entry of database data can be done efficiently and securely. The service or screen may be referred to as an “Online ID Badge.”

Numerous further advantages attend the invention.

The drawings form part of the specification hereof. With respect to the drawings, which are not necessarily drawn to scale, the following is briefly noted:

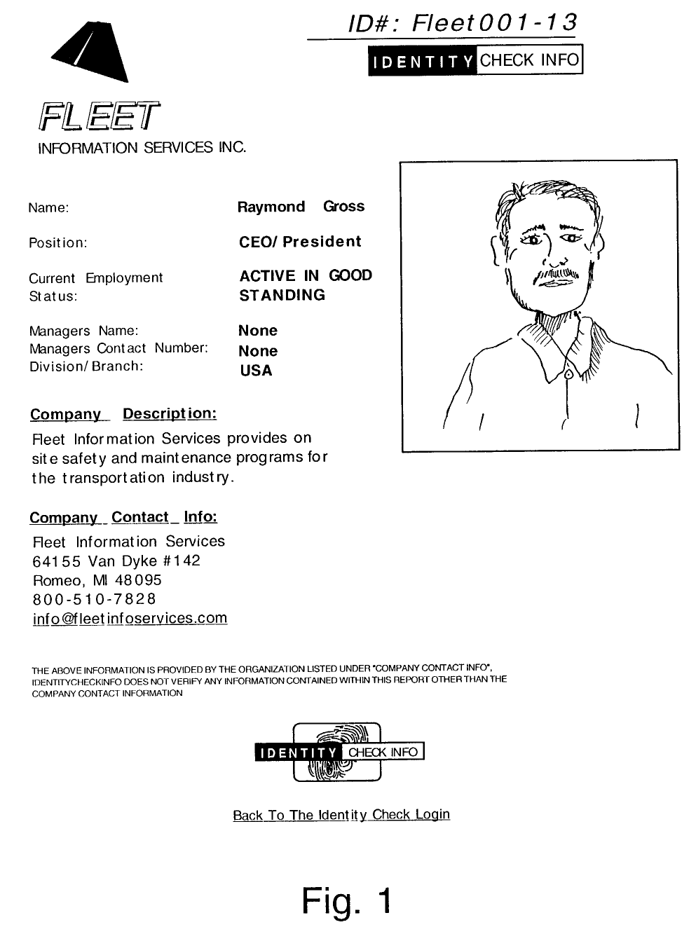

FIG. 1 is a plan view of a screen that can be viewed through a portal, which provides an individual report of a candidate that is viewed by screening personnel at the portal.

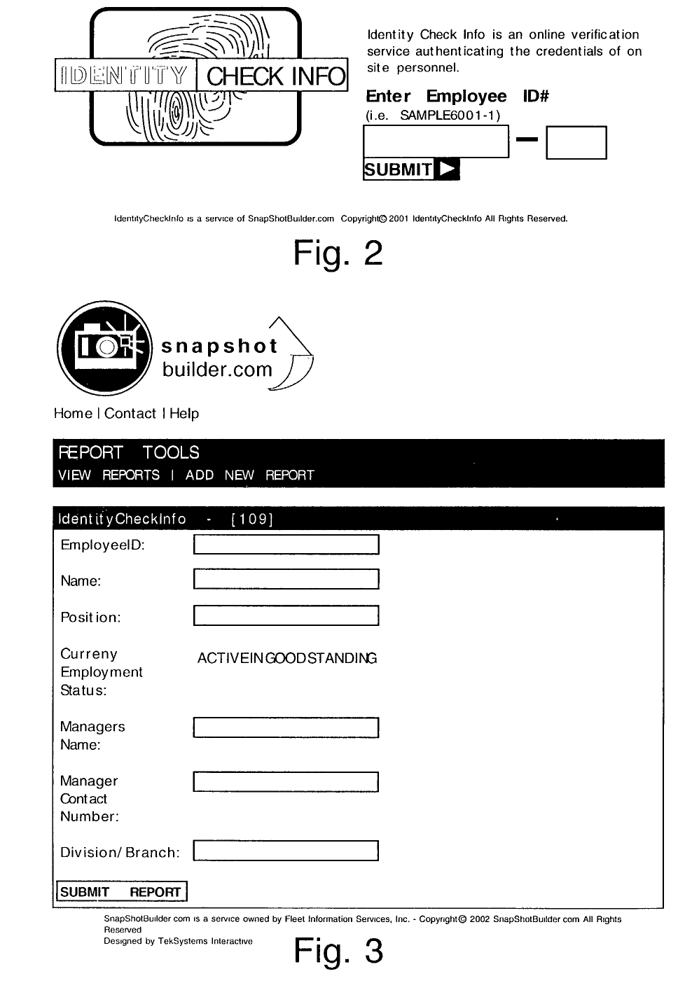

FIG. 2 is a plan view of a screen that can be viewed through a portal, which provides a prompt to obtain the individual report of FIG. 1.

FIG. 3 is a plan view of a screen that can be viewed through a portal of a system administrator, which provides a series of prompts to enter personnel data and information so that the individual report of FIG. 1 may be generated.

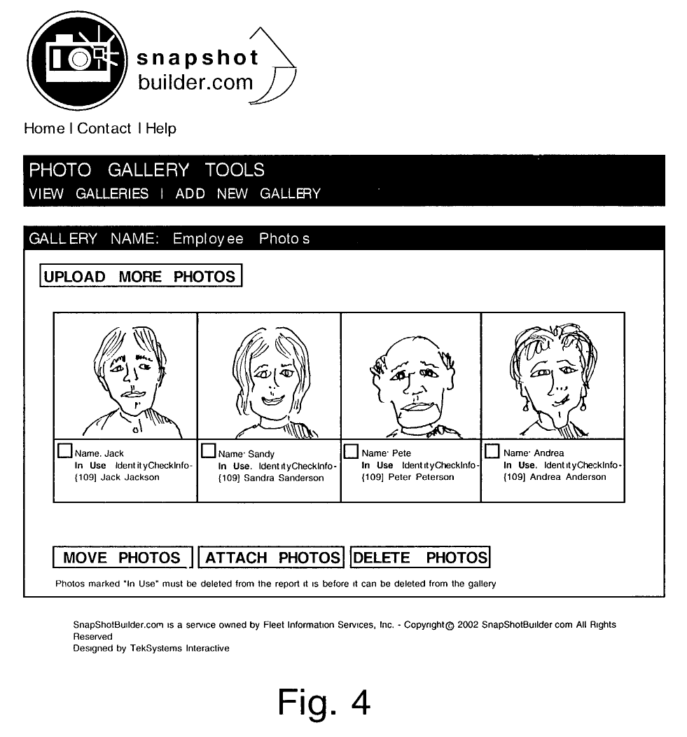

FIG. 4 is a plan view of a screen that can be viewed through the portal of the system administrator, which provides a gallery of employee photographs for use with the screen of FIG. 3.

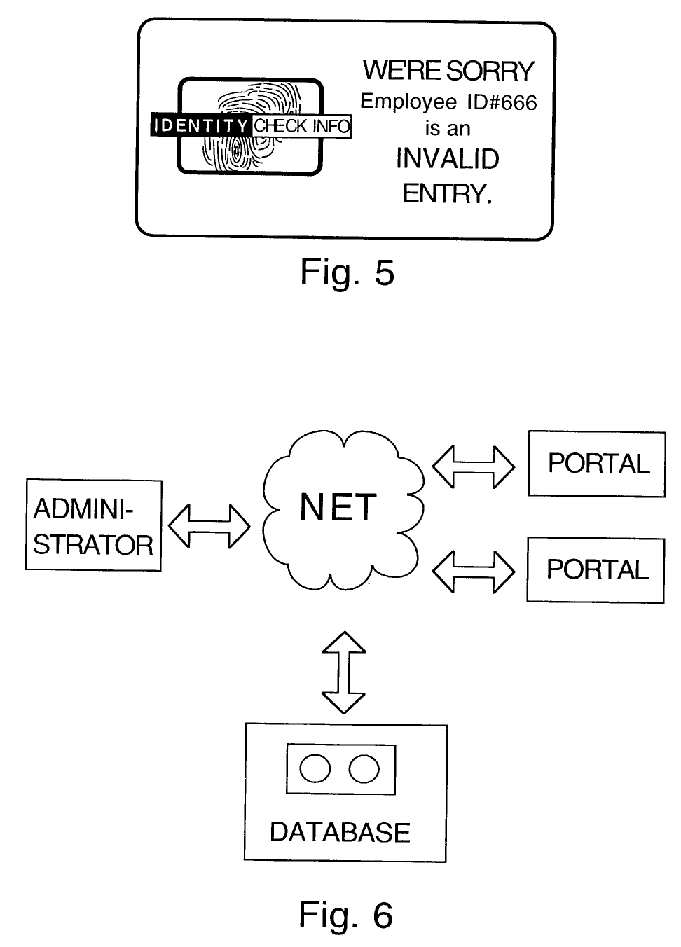

FIG. 5 is a plan view of a screen that can be viewed through a portal, which provides a response when a proposed identity of a candidate does not match any information in an employee database.

FIG. 6 is a plan view of the invention, which may be practiced over a computer network system.

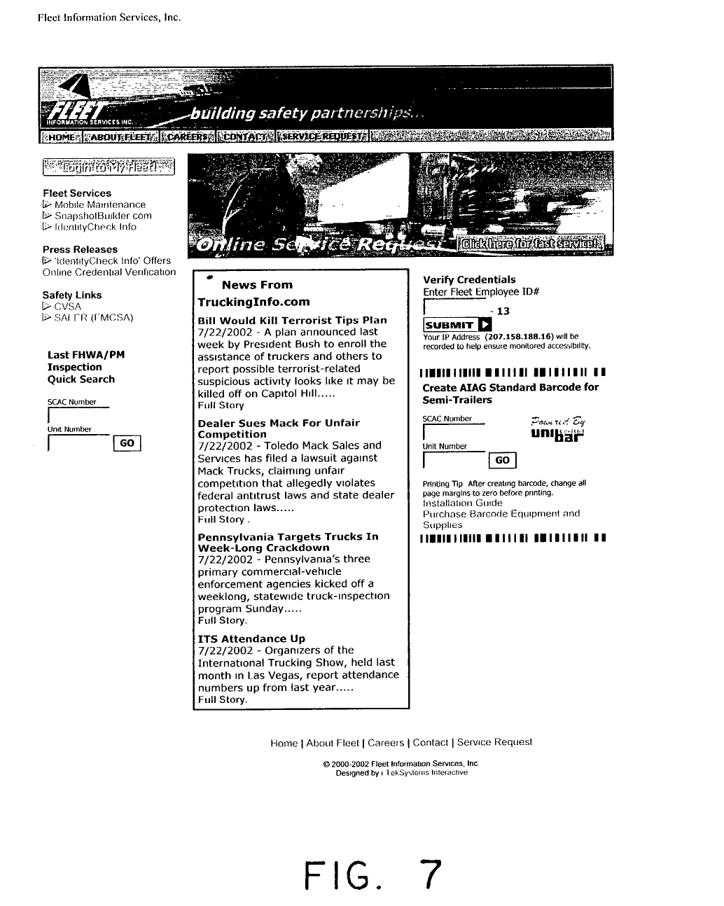

FIG. 7 is a plan view of a screen having a mini-portal on a customer's web site home page, which provides a prompt to obtain an individual report such as the positive report of of FIG. 1 or the negative report of FIG. 5. Compare, FIG. 2.

The invention can be further understood by the following detail, which may be read in view of the drawings. Such is to be taken in an illustrative and not necessarily limiting sense.

In the practice of the invention, the method may be carried out over any suitable communication system, for instance, a net, for example, an intranet or extranet and/or the Internet computer network, which may be restricted or global in reach and effect.

A computer database is provided. The database is structured to allow multi-user access and dynamic reporting of personnel data contained within the database. Thus, many users may access the database, sequentially or simultaneously. A user may be in a location remote from the computer database site. As used herein, the term, “dynamic reporting,” refers to a system that permits a user to view records and data in the database immediately after entry of the records and data into the database, which implies that the records and data are maintained on a regular basis or otherwise as needed. A commercial example of such a database system is provided by SnapShotBuilder.com, and an outline of the Snapshot Builder application is set forth as follows:

Home Page

Introductory Information

Links

FAQ

Signup

Stores Client Profile as Inactive, Including Account Type

Stores User Profile as Inactive

Sends Client Confirmation to Registered E-mail

Sends Application Data to Snapshot Builder for Verification

Login

SnapshotBuilder.com

Password Access

IdentityCheck.Info Service

IdentityCheck.Info Portal

IdentityCheck.Info Report-Form

Optional Biometric Fingerprint Verification Services

User Licensing

Client Integration Software

Fingerprint Scanning Device

Report-Form Management

Creation Wizard

Delete Function

Report Management

Submit Report Using Existing Report-Forms

View Reports with Searchability

E-mail Forwarding Feature

MTMI, Format

Report Data Editing with Order Priority Feature

Delete Function

Photo Management

Multi-Gallery Creation

Upload Photos

Auto-Indexing

Auto-Thumbnailing

Attach to Existing Reports

Delete Function

Media/Video Gallery

Multi-Gallery Creation

Upload Files

Auto-Indexing

Attach to Existing Reports

Delete Function

Sub-Client Management

Add Sub-Client Profile

Report Viewing Feature for Customers

Edit Sub-Client Profile

Delete Sub-Client Function

User Management

Add User Profile

Signature on File Feature

Edit User Profile

Delete User Function

Client Management

Add Client Profile

Edit Client Profile

Delete Client Function

Removes All Items Associated to the Account

Users

Reports

Photos

Media.

Preferably, data, for example, employee data, are entered into the database by an authorized client administrator. The client administrator is typically a trusted employee or agent who can be relied upon to accurately enter and maintain an organization's, association's or individual's personnel data on the database. Preferably, in order to prevent unauthorized entry of personnel data, the client administrator for an entity accessing the database utilizes a two-step login procedure. This procedure generally includes a first step of entering a password and a second step of transmitting to the database a fingerprint scan and/or scan of other biometric data such as retinal scan, voiceprint, and so forth and the like. The fingerprint scan may be accomplished by employment of a Biometric Fingerprint Scanner, and other biometric scan(s) may be accomplished by analogous devices also known in the art. Upon accessing the database, the client administrator enters personnel data (employee information) into the database. This personnel data can include the name and/or logo of the company or other organization, or even that of an individual solo operator; the employee's or solo operator's name, position, employment or other status such as licensing, any manager's name or name of another contact such as a peer or trusted subordinate, contact telephone number(s), division/branch information, organization or business description, organization contact information, an image of the employee or individual, the employee's identification (ID) number or other ID number such as a professional license number, and level of security clearance possessed by the employee or individual such as from a branch of the civil government, military, or civilian business. The image is desirably a photograph, for example, in frontal and/or side portrait form. See, FIGS. 1, 3 and 4. The personnel data may be manually entered into the database or automatically entered by uploading the same through employment of a template. If data are manually entered, preferably a standard template, which contains the same type of information for all employees, is provided in order to eliminate the need to input redundant information. Preferably, encryption technology prevents outside access to the records, which the client administrator can create and update, and periodically the client organization is surveyed to verify that employee reports are being kept current with regard to employment status.

As data are entered into the system, users wishing to verify a candidate employee's or individual's status accesses the database. Preferably this is carried out through the use of a network portal, for example, a web page. See, FIGS. 2 and 7. At this portal, the user is provided with a data field in which to enter candidate information, for example, an employee identification number. If the entry of data matches data for an individual in the database, the user is provided with a report for that person which includes the image, for example, a photograph, of the individual corresponding to the data entry, and any additional data from the database. See, FIG. 1. If the data is entered incorrectly or does not exist in the database, the user may be provided with a notice that the requested individual data is not available. See, FIG. 5. Thus, a portal that permits access to said database is provided; individual data to be matched against data contained in said database is received through the portal; and an individual report is transmitted, which includes an image of an individual and an identification number of the individual.

The invention may be practiced over any suitable computer communications network, to which parts of the invention are electronically connected and through which communication is carried out. See, FIG. 6.

Thus, for example, the identity of on-site repairmen, courier drivers, airport personnel, attorneys, laboratory technicians, civilian government and military employees, and so forth, can be readily verified. And so, the invention can serve to determine whether or not a photo-ID presented for identification is valid; and, moreover, can serve to identify a candidate individual who does not regularly carry a photo-ID but rather, say, carries an alpha/numeric-ID as a go or no-go by accessing his image and comparing it to the individual standing before the interested person at the portal. Therefore, the invention includes and provides a proactive security feature that allows customers, suppliers, and the general public the ability to verify the employment credentials of onsite personnel. Simply by entering an ID number candidate, customers and suppliers can confirm that a person does or does not represent an organization. The ID number can be supplied to customers and suppliers in advance, or can be read and entered directly from an ID badge. ID numbers can be included in e-mail or other correspondence so that organizations conducting business online can confirm credentials. Homeowners appreciate the fact that by viewing a candidate's identity report and photograph in advance they will have the peace-of-mind of knowing whom to expect at their doorstep.

The present invention is thus provided, to include by reference to certain preferred versions whereof. Various features, parts, subcombinations or combinations can be employed with or without reference to other features, parts, subcombinations or combinations in the practice of the invention, and numerous adaptations, modifications and versions that are not necessarily those which are preferred or otherwise expressed as set forth above can be effected within its spirit, the literal claim scope of which is particularly pointed out as follows:

I claim:

1. A method for providing identity and security information, which comprises steps of
providing a computer database structured to allow multi-user access and dynamic reporting of personnel data contained within said database;
providing a portal that permits access to said database;
receiving through said portal individual data to be matched against data contained in said database; and
transmitting an individual report, which includes an image of an individual and an identification character set of said individual.

2. The method of claim 1, wherein a system administrator enters said personnel data.

3. The method of claim 1, which employs the Internet.

4. The method of claim 2, which employs the Internet.

5. The method of claim 1, wherein the image is a portrait.

6. The method of claim 2, wherein the image is a portrait.

7. The method of claim 3, wherein the image is a portrait.

8. The method of claim 4, wherein the image is a portrait.

9. The method of claim 1, which is conducted in conjunction with on-site repair.

10. The method of claim 2, which is conducted in conjunction with on-site repair.

11. The method of claim 8, which is conducted in conjunction with on-site repair.

12. The method of claim 1, which is conducted in conjunction with delivery services.

13. The method of claim 2, which is conducted in conjunction with delivery services.

14. The method of claim 8, which is conducted in conjunction with delivery services.

15. The method of claim 1, which is conducted in conjunction with public transportation security operations.

16. The method of claim 2, which is conducted in conjunction with public transportation security operations.

17. The method of claim 8, which is conducted in conjunction with public transportation security operations.

18. A system for providing identity and security information, which comprises a computer having a database structured to allow multi-user access and dynamic reporting of personnel data contained therein, wherein an individual report, which includes an image and an identification number of said individual, can be transmitted from the database to a portal that permits access to the database and that permits receipt of individual data to be matched against data contained in the database, at a request from the portal.

19. The system of claim 9, in which a system administrator can enter the personnel data.

20. The system of claim 19, further comprising the portal.
